(19) United States
(12) Patent Application Publication
(10) Pub. No.: US 2004/0111423 A1
(43) Pub. Date: Jun. 10, 2004

(54) Method and system for secure, community profile generation and access via a communication system

(76) Inventors: John Irving, Ottowa (CA); Marcello Bursztein, Ottowa (CA); Steve Mulligan, Ottowa (CA); Patrick Lajeunesse, Ottowa (CA)

Correspondence Address: JAMES D. FORNARI, ESQ, SUITE 3-A, 1020 PARK AVENUE, NEW YORK, NY, 10028, US

(21) Appl. No.: 10/619,101

(22) Filed: Jul. 14, 2003

Related U.S. Application Data
(60) Provisional application No. 60/395,406, filed on Jul. 13, 2002.

(51) Int. Cl. G06F 17/00

(52) U.S. Cl. 707/100

(57) ABSTRACT

The present invention is a method and system for monitoring and filtering of data transmission to permit the creation of a secure web-based “virtual meeting place” through which a scientist, business person, educator or other individual can use the Internet to link themselves or their group or student to others to work collaboratively and create a shared environment. A community is formed by having a person who is interested in participating in a collaborative project or just exchanging data on a given subject submit preliminary profile data to a digital storage center. The data may contain a description of the project and a general description of the of the collaboration level sought. A first filter system is employed to ascertain, verify and control the entrance of data to ensure the legitimacy of the entering party. A profile is then crated and, in conjunction with a search engine, the data storage center and other related locations are searched for compatible profiles and a community is created. The system also contains the capability of dynamic filtering and monitoring to provide a safe and secure community and to increase the perceived feeling of the nature of the community.

### BACKGROUND OF THE INVENTION

Collaborative effort has the capability of helping to enhance virtually every endeavor, be it in the education field, business or dissemination of ideas. However, sharing information was often a difficult process. People could be thousands of miles apart and the transmittal of data could take days or weeks. The ability for collaborators to talk could be hampered by the cost or possible total absence of telecommunication facilities to permit the interaction. Finding partners with whom to share information was time-consuming and depended on the ability to conduct a search to locate people interested in the same topic.

Similarly, in a business context, it was always important for individuals working on similar projects to confer and exchange ideas. However, this often required meetings document exchanges and, if the project was of a technical nature, possible duplication of effort and facilities. Creating any form of collaboration required time, effort and follow up on leads to create a community of participants who wanted to converse or exchange ideas. Although the process was laborious, there was little alternative.

Universities and some high tech companies saw the need to facilitate such information transfer and created the seeds of what is now the Internet. Technology and information transfer have enhanced the collaborative effort of businesses, schools and government and permitted data to be obtained by virtually everyone for use in their every day life. As a part of this shared experience, chat rooms and other focus groups have emerged on the information highway. The exchange of information has proliferated and it is sometimes difficult to distinguish what is valid information from what is unverified and incorrect data.

It is also important to permit individuals to create their own “shared environment” where they can meet with others who have similar interests and exchange information in a secure manner. While this is particularly critical to business, it is equally important to individuals. Businesses would not want competitors to know of their activities any more than individuals who are sharing information would not want random people to gain access to that “shared environment”. It is thus important to create a blind but accessible pool which contains both public and private information and to permit individuals who are searching for a collaborative environment controlled access to the pool. The greater is the number of participants, the more enriched is the discussion and general information transfer. The creation of shared environments and relationships among the participants over the Internet permits expansion of the initial collaboration into other areas, as the interaction progresses, while still keeping the overall community secure. In order to effectively achieve this goal it is necessary to create both the pool or global community, make it secure and permit it to be searched for common interests.

### DESCRIPTION OF THE METHOD AND SYSTEM

The method and system for monitoring and filtering of electronic data transmission permits the creation of a secure “virtual meeting place” through which a scientist, business person, educator or other individual can use the Internet to link themselves or their group or students to others to work collaboratively and create a “shared environment”. A community is formed by having a person who in interested in participating in a collaborative project or just exchange information on a given subject submit preliminary profile data to a digital data storage center. The data generally contains a description of the project interest, the general level of information sought to be exchanged and general information about the person who is seeking to either create or join a group. A first filter system is employed to ascertain and control the entrance of data in order to ensure that the entering party is actually a valid participant and someone who is should be part of the community and its blind pool. Once a prospective participant is validated, the participant specific material is entered into the community creation data base, along with any project specific inquiries. The data is then compiled and stored.

The participant can create an account which is globally accessible within the community and is intended to describe the participant's group or project profile. The participant also has the option of making the profile public or not. If it is not public, then the participant will maintain an individual profile and project rather than a group profile. A participant can also create and maintain multiple profiles so that they can participate in multiple projects, either which they are creating or which they wish to be a part of. The multiple profile generation and storage creates a community which is larger than the mere number of physical participants. The information coming into each account may be filtered through a multi-level security filter that defines different levels of control.

Once the participant is accepted into the data storage system, a search engine permits them to search anywhere within the data storage system's world of “profiles” for compatible projects, profiles or “shared environments”. The participant can, using the search engine, plan collaborative Internet activities in a “shared learning” context. They can permit the participant to go “on-line” to link to other groups to work collaboratively to further enrich any topic within the community. By permitting participant to create multiple profiles, it allows the creation of a large on-line community with multiple “shared environments”.

Although dynamic filtering may not be necessary in certain “shared environments”, the ability to have some filtering and monitoring can further enhance the perceived safe and secure nature of the community. The system may also permit security to be controlled from a centralized location as a function of the particular “shared environment” that is created, before the information is passed to the to a network and to the particular “shared environment”. The filtering level component permits each project group within the network to be monitored to a degree that is participant designated and appropriate for the various members of the “environment”. The system is designed to permit an accepted participant who may have been designated as the monitor for the “shared environment” to receive a copy of messages that are sent or received in an account. The flagging filter component of the system will scan each message sent or received for words that are on a master flagged word list which is participant designated. If a word on the master flagged word list is found in the message, the message is routed to the monitor's account and will not be released until it is reviewed and its delivery or transmittal is authorized.

### EXAMPLE APPLICATIONS

The applications for profile generation and “shared environment” creation go beyond the interaction of two individuals or even two groups. They permit searches to be conducted to create sub-communities and common interest groups. They allow security within the “shared environment”, while still permitting new participants to join. They also allow sharing of work among the participants, according to their expressed desires and submitted profiles.

### Example 1

Interface Profiles

A “Personal Profile” may be modified to also have “Personal Information” in the profile submitted. The personal profile can be accessed generally or can have sub-categories for access purposes. It can have a public profile or a group profile. It can also have a project profile which does not contain personal information other than a blind contact. By way of example, the following can be a typical profile generation for use in conjunction with the search engine:

Class profile

In the profile creation interface, a pull down is added similar to access levels:

Make my profile accessible to users within:

Do not share profile

$groupname *

$environmentname

$resellername **

Global Community

*—Does not appear if there's only one entity in the license

**—Can default to designated entity for those without another reseller

Moderation

Every submitted profile must be approved by administrators who are responsible for community before they go live. Community profiles can make profiles live immediately upon creation if their access is something which has been pre-approved via another administrator or because it has been a part of the community previously.

If the profile is new, it is handled by a screening process and the creation of a blind reply mode following approval.

Search

Within the interface, “Search only my community” checkbox may be replaced by a pull-down with the same values given in “Class profile” above.

Searches are limited to the indicated community division and below.

The default value is can be designated as “Global”.

Searches on the server site only find profiles with global access or in within a reseller community.

### Example 2

Personal Profiles

Users can create class/or personal profiles. Personal profiles need contain only a subset of the information currently stored with a class profile.

### Example 3

Customized Profile Options/Search Results

Users will be able to identify particular labels to be associated with the profile. Search pulls its values from the same choices. These labels are defined in the administration interface. This would allow them to add phone number, for example.

Administrators will be able to determine what fields show up in search results for profiles within their community. This would allow them to add email address or telephone, for example, or remove the city field in case they're all in the same one. Found approved profiles will have the common fields and the same as have defined above.

### Example 4

Administrator Control/Moderation

New profile preferences pages can have the following options, among others:

Administrators can indicate whether users can create personal and or group profiles and if so, at what level they can be accessed. The profile interface access pull-down then reflects the possibilities the administrator has chosen.

Administrators can indicate whether profiles need to be approved (by them or another administrator) before they go live or not.

Administrators can indicate whether users will be able to find profiles outside of their community.

### Example 5

Profile Moderation

The system can provide interface/functionality to allow assigned users to moderate profiles. It can also provide interface/functionality to allow assigned users to deactivate existing profiles.

### Example 6

Multilingual Descriptions/Titles

The system will permit participants to have the option of entering their profile in any supported language. This can be done manually or using instant translation. When searching, users can indicate that they wish to search for the entered term in a particular language or all languages.

### Example 7

Multiple Profiles

The system will permit additional interfaces to allow the creation/management of multiple profiles for any given participant, which will permit expansion of the community beyond the mere number of participants.

We claim:

1. An apparatus for community generation by monitoring and filtering data transmission to screen unwanted material comprising a community filter means to permit qualified individuals to join a specific community, profile creation means to describe each qualified individual, a hierarchical infrastructure for initially screening data to create a varying degrees of accessibility to input data, a dynamic search engine to permit those members of the community to search the data initially screened within the limit permitted by the hierarchical infrastructure, a dynamic filter controlled by a central location to permit monitoring and filtering of the data transmitted and structuring of the infrastructure and a flagging filter component to scan messages and data prior to delivery.
